(19) United States
(12) Patent Application Publication
(10) Pub. No.: US 2024/0092289 A1
(43) Pub. Date: Mar. 21, 2024

(54) METHOD FOR ELECTRICAL CENTER RECONFIGURABLE EFUSE SOFTWARE SYNCHRONIZATION USING SERIAL DATA PROTOCOL

(71) Applicant: GM Global Technology Operations LLC, Detroit, MI (US)

(72) Inventors: James Morrison, Sebringville (CA); Lyall Kenneth Winger, Waterloo (CA); Suresh Gopalakrishnan, Troy, MI (US)

(21) Appl. No.: 17/945,274

(22) Filed: Sep. 15, 2022

(51) Int. Cl. B60R 16/023

(52) U.S. Cl. CPC B60R 16/0238; B60R 16/0239

(57) ABSTRACT

A vehicle, an electrical system of the vehicle and a method of operating the vehicle. The electrical system includes an electrical load and an energy center for distribution of power to the electrical load. The energy center includes a fuse cluster having a plurality of electronic fuses, and the electrical load is coupled to the energy center via the plurality of electronic fuses of the fuse cluster. A selected electronic fuse of the fuse cluster is configured to detect a fault at the selected electronic fuse, make itself a master fuse of the fuse cluster in response to detecting the fault and control an operation of the fuse cluster.

### INTRODUCTION

The subject disclosure relates to electronic fuses in an electrical system of a vehicle and, in particular, to a method of synchronizing operation of the electronic fuses to accommodate electrical loads that span multiple electronic fuses in parallel.

An electrical system of a vehicle includes one or more power sources and a plurality of electrical loads that draw power from the power source. An energy center can be placed between the power source and the plurality of electrical loads to control the distribution of the power to the electrical loads. The energy center can have a plurality of outlets, each having an associated electronic fuse. Some electrical loads will require being plugged into more than one of these outlets and thus will require the use of many fuses. If one of these fuses blows, excess power can be transferred through the other outputs, resulting in excess power loads across the remaining outlets. Accordingly, it is desirable to provide a system and method for synchronizing operation of electronic fuses.

### SUMMARY

In one exemplary embodiment, a method of operating a vehicle is disclosed. A fault is detected at a selected electronic fuse of a fuse cluster of the vehicle, the fuse cluster including a plurality of electronic fuses coupled to an electrical load. An operation of the fuse cluster is controller via a master fuse of the fuse cluster, wherein the selected electronic fuse makes itself the master fuse in response to detecting the fault and controls the operation of the fuse cluster.

In addition to one or more of the features described herein, the method further includes defining the fuse cluster for the electrical load and assigning master fuse status to one of the plurality of electronic fuses of the fuse cluster. In an embodiment, the selected electronic fuse is not the master fuse when the fuse cluster is defined. Controlling the operation of the fuse cluster further includes sending a control signal from the master fuse to a slave fuse of the fuse cluster. Controlling the operation of the fuse cluster further includes at least one of controlling a pulse width modulation for the electrical load and synchronizing turning off the electronic fuses of the fuse cluster. The method further includes turning off the fuses of the fuse cluster via a signal from a controller. The signal from the controller is identified at the fuse cluster via a cluster index associated with the signal.

In another exemplary embodiment, an electrical system of a vehicle is disclosed. The electrical system includes an electrical load and an energy center for distribution of power to the electrical load. The energy center includes a fuse cluster having a plurality of electronic fuses, and the electrical load is coupled to the energy center via the plurality of electronic fuses of the fuse cluster. A selected electronic fuse of the fuse cluster is configured to detect a fault at the selected electronic fuse, make itself a master fuse of the fuse cluster in response to detecting the fault and control an operation of the fuse cluster.

In addition to one or more of the features described herein, the electrical system further includes a controller configured to assign the plurality of electronic fuses to the fuse cluster and assign master fuse status to one of the plurality of electronic fuses of the fuse cluster. In an embodiment, the selected electronic fuse is not the master fuse when the fuse cluster is defined. The master fuse is configured to control the operation of the fuse cluster by sending a control signal from the master fuse to a slave fuse of the fuse cluster. The operation of the fuse cluster further includes at least one of controlling a pulse width modulation for the electrical load and synchronizing turning off the electronic fuses of the fuse cluster. The controller is further configured to turn off the electronic fuses via a signal from the controller. The signal from the controller includes a cluster index that identifies the signal to the fuse cluster.

In yet another exemplary embodiment, a vehicle is disclosed. The vehicle includes an electrical load and an energy center for distribution of power to the electrical load. The energy center includes a fuse cluster having a plurality of electronic fuses, and the electrical load is coupled to the energy center via the plurality of electronic fuses of the fuse cluster. A selected electronic fuse of the fuse cluster is configured to detect a fault at the selected electronic fuse, make itself a master fuse of the fuse cluster in response to detecting the fault, and control an operation of the fuse cluster.

In addition to one or more of the features described herein, the vehicle further includes a controller configured to assign the plurality of electronic fuses to the fuse cluster and assign master fuse status to one of the plurality of electronic fuses of the fuse cluster. In an embodiment, the selected electronic fuse is not the master fuse when the fuse cluster is defined. The master fuse is configured to control the operation of the fuse cluster by sending a control signal from the master fuse to a slave fuse of the fuse cluster. The operation of the fuse cluster further includes at least one of controlling a pulse width modulation for the electrical load and synchronizing turning off the electronic fuses of the fuse cluster. The controller is further configured to turn off the electronic fuses via a signal from the controller.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows a vehicle in accordance with an exemplary embodiment;

FIG. 2 shows a schematic diagram of the electrical system of the vehicle;

FIG. 3 is a diagram illustrating operation of a fuse cluster during a blow-out event, in one embodiment;

FIG. 4 is a diagram illustrating a method of operating a fuse cluster to perform a pulse width modulation at an electrical load, in a first embodiment; and

FIG. 5 is a diagram illustrating a method of operating a fuse cluster to perform a pulse width modulation at an electrical load, in a second embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

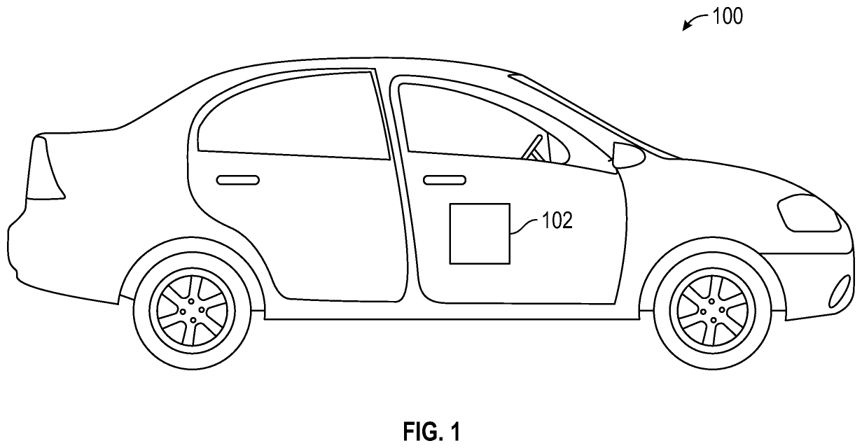

In accordance with an exemplary embodiment, FIG. 1 shows a vehicle 100. The vehicle 100 can be a gas-powered vehicle, an electric vehicle or a hybrid vehicle, in various embodiments. The vehicle 100 generally includes an electrical system 102.

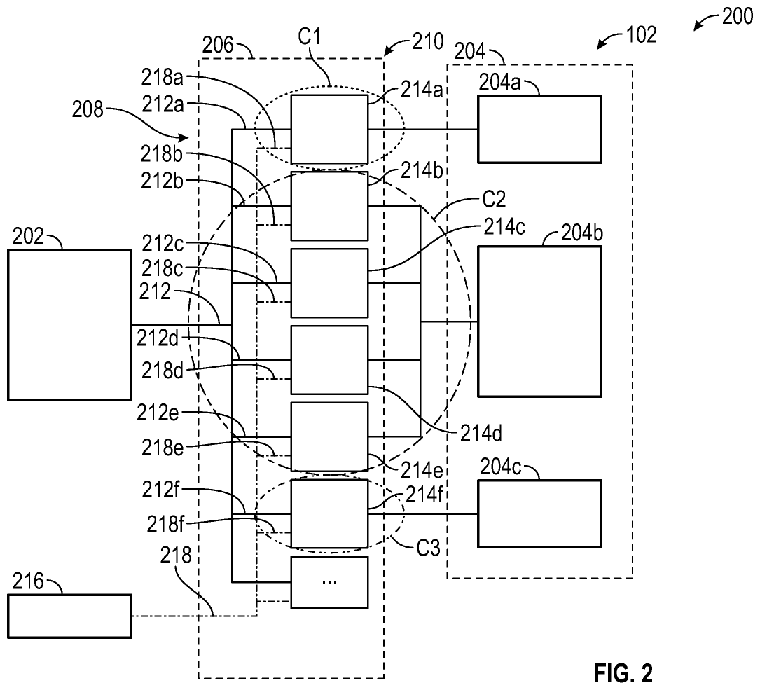

FIG. 2 shows a schematic diagram 200 of the electrical system 102 of the vehicle 100. The electrical system 102 includes a power source 202, one or more electrical loads 204 and a smart energy center 206 that electrically couples the power source to the one or more electrical loads. The power source 202 can be a plurality of power sources and can include a battery, a generator, etc. The one or more electrical loads 204 can include devices such as a starter motor, a generator, power windows, communication systems, entertainment systems, etc. The smart energy center 206 includes sensors for monitoring and controlling operation of the electrical loads and circuitry for distributing power from the power source 202 to the one or more electrical loads 204 in accordance with their power demands.

The smart energy center 206 includes a power input side 208 and a load connection side 210. A bus line 212 of the smart energy center 206 connects to the power source 202 at the power input side 208. The bus line 212 splits into a plurality of bus branches 212a-212f. Each of the plurality of bus branches 212a-212f leads to an outlet or socket at the load connection side 210 and includes an associated one of eFuses 214a-214f. An eFuse or electronic fuse is a solid-state fuse that can be programmed to activate (blow) when a current along the branch exceeds a threshold current. The threshold current can be a programmed value and can be reprogrammed as desired to accommodate different electrical loads, for example, when an electrical load having a first power requirement is removed and replaced with an electrical load having a second power requirement. The eFuse includes a transistor that controls the flow of current through the branch and circuitry that controls operation of the transistor, such as placing the transistor in one of an ON state or an OFF state. As shown in FIG. 2 and discussed herein, an electrical load can be plugged into multiple outlets, thereby connecting to multiple bus branches and employing the use of multiple eFuses. Although six bus branches are shown for illustrative purposes this is not meant to be a limitation of the invention.

A first electrical load 204a, second electrical load 204b and third electrical load 204c are shown plugged into the load connection side 210 of the smart energy center 206 for illustrative purposes. The first electrical load 204a is connected to bus branch 212a and uses eFuse 214a. The second electrical load 204b is connected to bus branches 212b-212e and uses eFuses 214b-214e. The second electrical load 204b illustrates that an electrical load can require more power that can be supplied along a single branch. The third electrical load 204c is connected to bus branch 212f and uses eFuse 214f In alternative embodiments, a load (e.g., third electrical load 204c) can be either an auxiliary power source or a load that behaves like a power source intermittently (e.g., a regenerative braking system).

A controller 216 or microprocessor controls a configuration of the smart energy center 206. The controller 216 can be integrated into the smart energy center 206 or can be a component that is separate from the smart energy center, as shown in FIG. 2. The controller 216 may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. The controller 216 may also include a non-transitory computer-readable medium that stores instructions which are processed by one or more processors of the controller to implement processes detailed herein.

The controller 216 communicates with the eFuses 214a-214f along a control bus 218. The control bus 218 splits into control branches 218a-218f, each of which connects to their respective eFuses 214a-214f. In an embodiment, the controller 216 can group or assign the fuses to a fuse cluster when the electrical loads 204 are connected to the bus branches. The controller 216 can assign each eFuse a cluster index to indicate its membership in a fuse cluster. In the illustrative embodiment of FIG. 2, eFuse 214a is assigned to a first fuse cluster C1, eFuses 214b-214e are assigned to a second fuse cluster C2 and eFuse 214f is assigned to a third fuse cluster C3. A cluster map tracks which eFuses are assigned to which fuse cluster. Table 1 shows a cluster map for the configuration illustrated in FIG. 2.

TABLE 1

| eFuse Index | Cluster Index |
|---|---|
| 1 | 1 |
| 2 | 2 |
| 3 | 2 |
| 4 | 2 |
| 5 | 2 |
| 6 | 3 |
| . . . | . . . |
| n | m |

For fuse clusters that have multiple eFuses, the controller 216 can assign one of the eFuses to be a master eFuse with the remaining eFuses of the fuse cluster as slave eFuses. The master eFuse can control and coordinate operation of the slave eFuses of the fuse cluster to perform various operations, such as pulse width modulation of the electrical load, etc. In addition, the master eFuse can synchronize operation of the slave eFuses of the fuse cluster in order to turn off or blow in a way that prevents or reduces a power overload along any one bus branch.

The controller 216 can send various messages to the eFuses 214a-214f. The messages can include an eFuse index (eFuse ID) and/or a cluster index (Cluster ID) to allow an eFuse to identify itself as the intended recipient of the signal.

In an example, the controller 216 can send a message (ClusterIDSet) identifying eFuseID and clusterID to the eFuses to assign them to their respective fuse clusters. In another example, the controller 216 can send a message (ClusterPWMSetMaster) identifying an eFuseID to assign a master eFuse status to one of the eFuses of the fuse cluster. In yet another example, the controller 216 can send a message (ClusterON/OFF) identifying a cluster ID of the fuse cluster to turn on and/or off all of the eFuses of the fuse cluster. In yet another example, the controller 216 can send a message (ClusterFault) identifying the cluster ID of the fuse cluster that instructs an eFuse of the fuse cluster to turn off if a fault occurs another eFuse of the fuse cluster. In yet another example, the controller 216 can send a message (ClusterPWMSyncON/OFF) identifying clusterID to synchronize an ON/OFF cycling of the eFuses of a fuse cluster to performing a pulse width modulation operation via the eFuses.

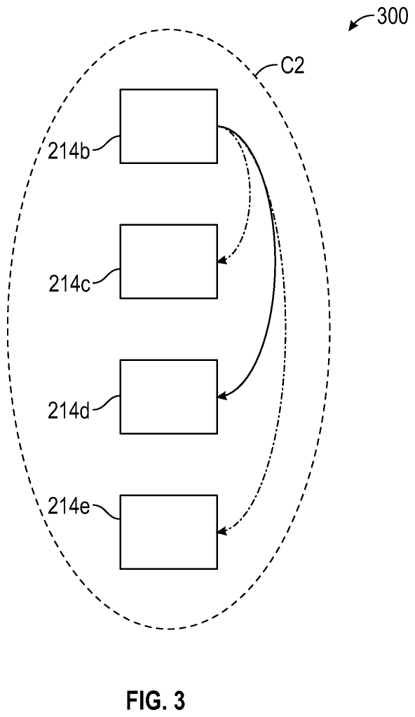

FIG. 3 is a diagram 300 illustrating operation of a fuse cluster during a blow-out event, in one embodiment. The second fuse cluster C2 of FIG. 2 is shown for illustrative purposes only. As an example, a fault or over current event occurs at a selected electronic fuse (e.g., eFuse 214b). Since eFuse 214b is not currently the master eFuse of the fuse cluster, it assigns itself to be the master fuse (or, equivalently, assumes master fuse status) upon detecting the fault. The eFuse 214b then sends out a control signal to the slave fuses (e.g., eFuses 214c, 214d and 214e) of the fuse cluster to instruct them to turn off. Since this control signal is received at the same time by the slave fuses, shutting down of the slave fuses is synchronized, allowing all of the electronic fuses of the fuse cluster to turn off at the same time. It is to be understood that any of eFuses 214b-214e can be assigned the status of master fuse when the fuse cluster is originally established or defined by the controller. Also, any of eFuses 214b-214e can detect a fault and make itself the master fuse of the fuse cluster based on the detection of the fault. Additionally, when the fault occurs at an eFuse that is already the master fuse of the fuse cluster, there is no change in the master-slave configuration of the eFuses 214b-214e in the second fuse cluster C2.

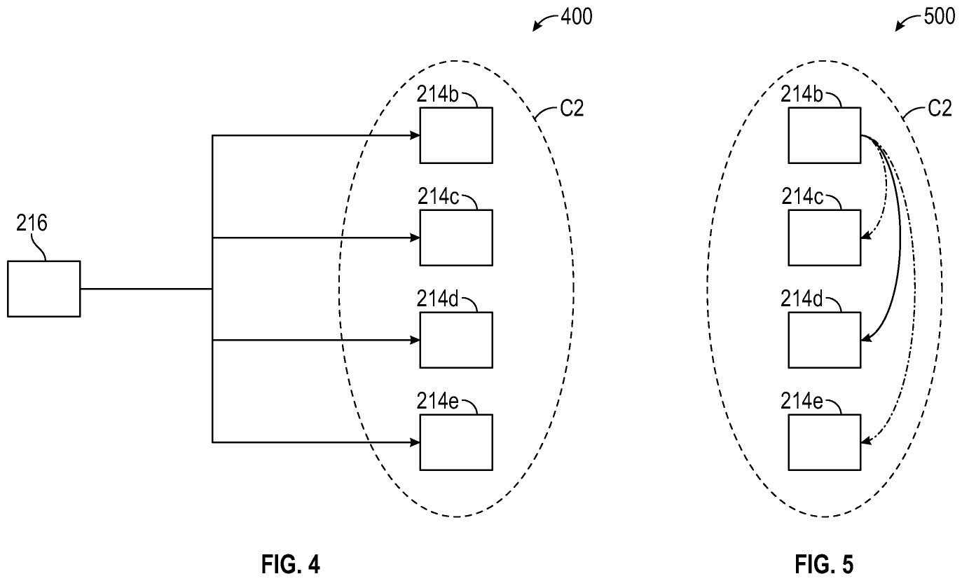

FIG. 4 is a diagram 400 illustrating a method of operating a fuse cluster to perform a pulse width modulation at an electrical load, in a first embodiment. The second fuse cluster C2 of FIG. 2 is shown for illustrative purposes only. The controller 216 sends the ClusterON/OFF message to the fuse cluster with an appropriate timing. The eFuses receive the message and turn on and off with an appropriate phase delay between them to allow the fuse cluster to perform pulse width modulation.

FIG. 5 is a diagram 500 illustrating a method of operating a fuse cluster to perform a pulse width modulation at an electrical load, in a second embodiment. The second fuse cluster C2 of FIG. 2 is shown for illustrative purposes only. The eFuse 214b is configured as the master eFuse and sends out a ClusterPWMSyncON/OFF message to the other eFuses in the fuse cluster to perform the pulse width modulation. The master eFuse (e.g., eFuse 214b) delays its own turning on and off to be in sync with the slave eFuses.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of operating a vehicle, comprising:
detecting a fault at a selected electronic fuse of a fuse cluster of the vehicle, the fuse cluster including a plurality of electronic fuses coupled to an electrical load; and
controlling an operation of the fuse cluster via a master fuse of the fuse cluster, wherein the selected electronic fuse makes itself the master fuse in response to detecting the fault and controls the operation of the fuse cluster.

2. The method of claim 1, further comprising defining the fuse cluster for the electrical load and assigning master fuse status to one of the plurality of electronic fuses of the fuse cluster.

3. The method of claim 2, wherein the selected electronic fuse is not the master fuse when the fuse cluster is defined.

4. The method of claim 1, wherein controlling the operation of the fuse cluster further comprises sending a control signal from the master fuse to a slave fuse of the fuse cluster.

5. The method of claim 1, wherein controlling the operation of the fuse cluster further comprises at least one of: (i) controlling a pulse width modulation for the electrical load; and (ii) synchronizing turning off the electronic fuses of the fuse cluster.

6. The method of claim 5, further comprising turning off the fuses of the fuse cluster via a signal from a controller.

7. The method of claim 6, wherein the signal from the controller is identified at the fuse cluster via a cluster index associated with the signal.

8. An electrical system of a vehicle, comprising:
an electrical load; and
an energy center for distribution of power to the electrical load, the energy center includes a fuse cluster having a plurality of electronic fuses, wherein the electrical load is coupled to the energy center via the plurality of electronic fuses of the fuse cluster;
wherein a selected electronic fuse of the fuse cluster is configured to detect a fault at the selected electronic fuse, make itself a master fuse of the fuse cluster in response to detecting the fault, and control an operation of the fuse cluster.

9. The electrical system of claim 8, further comprising a controller configured to assign the plurality of electronic fuses to the fuse cluster and assign master fuse status to one of the plurality of electronic fuses of the fuse cluster.

10. The electrical system of claim 9, wherein the selected electronic fuse is not the master fuse when the fuse cluster is defined.

11. The electrical system of claim 8, wherein the master fuse is configured to control the operation of the fuse cluster by sending a control signal from the master fuse to a slave fuse of the fuse cluster.

12. The electrical system of claim 8, wherein the operation of the fuse cluster further comprises at least one of: (i) controlling a pulse width modulation for the electrical load; and (ii) synchronizing turning off the electronic fuses of the fuse cluster.

13. The electrical system of claim 12, wherein the controller is further configured to turn off the electronic fuses via a signal from the controller.

14. The electrical system of claim 13, wherein the signal from the controller includes a cluster index that identifies the signal to the fuse cluster.

15. A vehicle, comprising:
an electrical load; and
an energy center for distribution of power to the electrical load, the energy center includes a fuse cluster having a plurality of electronic fuses, wherein the electrical load is coupled to the energy center via the plurality of electronic fuses of the fuse cluster;
wherein a selected electronic fuse of the fuse cluster is configured to detect a fault at the selected electronic fuse, make itself a master fuse of the fuse cluster in response to detecting the fault, and control an operation of the fuse cluster.

16. The vehicle of claim 15, further comprising a controller configured to assign the plurality of electronic fuses to the fuse cluster and assign master fuse status to one of the plurality of electronic fuses of the fuse cluster.

17. The vehicle of claim 16, wherein the selected electronic fuse is not the master fuse when the fuse cluster is defined.

18. The vehicle of claim 15, wherein the master fuse is configured to control the operation of the fuse cluster by sending a control signal from the master fuse to a slave fuse of the fuse cluster.

19. The vehicle of claim 15, wherein the operation of the fuse cluster further comprises at least one of: (i) controlling a pulse width modulation for the electrical load; and (ii) synchronizing turning off the electronic fuses of the fuse cluster.

20. The vehicle of claim 19, wherein the controller is further configured to turn off the electronic fuses via a signal from the controller.
